(19) United States
(12) Patent Application Publication
(10) Pub. No.: US 2025/0180068 A1
(43) Pub. Date: Jun. 5, 2025

(54) METHOD FOR MANUFACTURING A GUIDE DEVICE WITH ROLLER BODIES FOR A MEDICAL MECHANISM

(71) Applicant: MPS Micro Precision Systems AG, Biel/Bienne (CH)

(72) Inventors: Vincent Wahli, Port (CH); Raphael Erard, Bevaix (CH); Arnaud Houriet, St-Imier (CH); Marc Salamin, Vercorin (CH); Yves Moser, Le Landeron (CH)

(73) Assignee: MPS Micro Precision Systems AG, Biel/Bienne (CH)

(21) Appl. No.: 18/846,098

(22) PCT Filed: Mar. 24, 2023
(86) PCT No.: PCT/IB2023/052909

§ 371 Date: Sep. 11, 2024

(30) Foreign Application Priority Data
Mar. 24, 2022 (CH) CH000331/2022
Mar. 24, 2022 (FR) FR2202652

(51) Int. Cl. F16C 29/04; C22F 1/18

(52) U.S. Cl. CPC F16C 29/04; C22F 1/183; F16C 2223/10

(57) ABSTRACT

The invention relates to a method of manufacturing a bearing (100) for a medical rolling bodies guide device, comprising components, at least one component (20; 6, 2, 4, 5, 5′) being made of titanium or a titanium alloy, the method comprising the steps of
processing the titanium or titanium alloy component;
performing a diffusion hardening treatment of the machined component, so that the component comprises a surface layer (21) having a hardness in the range 900 Hv-1100 Hv. The invention makes it possible to manufacture a medical rolling bodies guide device in a material which does not a priori have the properties required for these applications.

### TECHNICAL AREA

The present invention relates to a method of manufacturing a rolling bodies guide device for a watchmaking, medical, semiconductor or Ion-beam mechanism. It also concerns a rolling bodies guide device for watchmaking, medical, semiconductor or Ion-beam mechanisms. It also concerns a watchmaking mechanism, a medical device, a device for the semiconductor field or ion-beam applications comprising such a rolling bodies guide device.

### STATE OF THE ART

The term “rolling bodies guide device” refers to a device which comprises (at least) a first element, (at least) a second element and rolling bodies held between the first element and the second element, in order to facilitate the relative movement of the first element with respect to the second, or vice versa. A rolling bodies guide device in this context has a maximum static load factor CO of 2000 N, a maximum dynamic load factor C of 2000 N and rolling bodies with a maximum diameter of 1.6 mm.

In this context, the term “rolling bodies” refers to any body that can roll, such as, but not limited to, a ball or a roller, e.g. a cylindrical or conical roller, a needle, etc.

A rotary bearing is an example of a rolling bodies guide. It generally comprises (at least) one outer ring (the first element), (at least) one inner ring (the second element, which generally comprises two parts fixed to each other) and rolling bodies held between the outer ring and the inner ring. In some cases, a cage can be used to space the rolling bodies between the rings.

In general, the cage (also known as the rolling element separator) is a single-piece unit. The rolling bodies located between the bearing's inner and outer rings are generally held at regular intervals by the cage, which guides them and facilitates their rotation. The cage can also be composed of several independent segments. The cage can also perform additional functions to the spacing of the rolling bodies, such as, but not limited to, a locking function.

The number of points of contact (e.g. when the rolling bodies are balls) or lines of contact (e.g. when the rolling bodies are rollers) between the rolling bodies and the rings can vary according to the type of bearing.

The surface on which the rolling bodies roll is generally referred to as the raceway. It supports the loads (axial and/or radial) applied to the bearing.

A linear bearing is another example of a rolling bodies guide. It typically comprises a sleeve (the first element), a shaft (the second element) and rolling bodies held between the sleeve and the shaft. A linear bearing may include a cage to hold the rolling bodies and allow them to recirculate. In this case, the cage does not act as a rolling bodies separator. There is also a configuration in which the rolling bodies are inserted in a cage which acts as a rolling bodies separator. In this case, there is no recirculation of the rolling bodies.

A ball screw is another example of a rolling bodies guide. It generally comprises a nut (the first element), a screw (the second element) and rolling bodies held between the nut and the screw.

In general, rotary bearings are used to support and guide elements to be rotated, such as, but not limited to, gears, screws, axles, etc.; linear bearings are used to guide elements that move linearly, such as, but not limited to, an axle; ball screws are used to transform rotary motion into linear motion and vice versa, while minimizing friction (and maximizing efficiency).

In order to ensure that a rolling bodies guideway functions properly and has a long service life, certain properties of its components are desirable, in particular:
high precision of the rolling bodies geometry (e.g. ISO Grade 3);
good mechanical properties, e.g. hardness and Young's modulus (especially for the rolling bodies, for the rolling zones on the rolling bodies tracks of the first and/or second element);
geometric conformity of the rolling faces, both of the first element and of the second element.

Titanium or a titanium alloy offers a combination of properties that are attractive for a wide range of mechanical applications, in particular:
its relatively low density for dynamic applications;
its chemical stability for applications in contact with external environments;
its low magnetic permeability for applications where a remanent magnetic field is detrimental.

In addition to these characteristics, the chemical biocompatibility of titanium or a titanium alloy makes it a suitable material for the medical field.

In this context, the term “titanium alloy” refers to an alloy (especially a metal) that includes titanium and other chemical elements. Non-limiting examples of titanium alloys include phase alloys α, α/β, β, ω, etc.

However, the low Young's modulus and/or limited hardness (e.g. compared with steel) of titanium or a titanium alloy make it unsuitable for certain applications.

In the case of watchmaking or medical bearings, titanium or a titanium alloy would be the material of choice for the reasons mentioned above, in particular its insensitivity to magnetism and biocompatibility respectively. Its low density is also an advantage which may prove crucial for certain applications.

Titanium's low Young's modulus is not an obstacle to its use in rolling bodies guides for watchmaking or medical applications.

However, the very limited hardness that titanium can achieve is a blocking factor for its application in the field of guide devices for watchmaking or medical rolling bodies.

The latter are required to support high loads, while maintaining a small footprint. For example, the maximum diameter of the outer element (outer ring or bushing) of a rolling bodies guide for a watch or medical mechanism is 28 mm. The materials used must therefore have first-rate mechanical properties. The stresses in contact between the balls and the rolling surfaces are extremely high, for example, point stresses of the order of magnitude of 4600 MPa in the watchmaking or medical sector.

In the watchmaking and medical sectors, a high level of surface hardness is required to ensure that the rolling bodies guide device operates smoothly during use. The higher the hardness, the more the rolling bodies guide device will be able to withstand the heavy loads and stresses of daily use, thus prolonging its service life.

A wide variety of processes are available to impart high surface hardness to titanium.

PVD (Physical Vapour Deposition) and CVD (Chemical Vapour Deposition) deposition processes can deposit layers ranging from a few nanometres to a few micrometres on the surfaces of titanium components.

These treatments, e.g. TiN/CrN/TiC/TiCN etc. regularly used for cutting tool surfaces, have shown satisfactory results for many applications. However, in the case of guide devices with rolling watch and/or medical bodies, the maximum deposition thickness of the order of a few micrometers does not allow effective load transfer.

Moreover, the sharp boundary between the deposit and the base layer creates a discontinuity that is unfavorable to charge transfer between the deposit and the base layer.

DLC (diamond like carbon) treatments are a sub-family of PVD treatments. They enable the deposition of a carbon layer with a thickness generally between 0.5 μm and 3 μm, adopting a partial diamond structure. The layer consists of a fraction of carbon in diamond form (sp3 hybridization state), a fraction of graphite/graphene (sp2 hybridization state) and may also contain a certain amount of hydrogen. The properties of the layer depend on the proportions of these three constituents.

Despite their high surface hardness, DLC-type coatings are not suitable for rolling bodies guide devices for watchmaking and/or medical applications. This is because the thickness of the coating does not allow sufficient load transfer. Combined with variable (weak) adhesion of the coating to the surface, cases of layer fracture and delamination exist, making this treatment unworkable.

A titanium or titanium alloy surface can be anodized to impart color. Anodizing titanium or a titanium alloy also modifies the coefficient of friction and surface topology of the base component. However, the properties of the anodized titanium or titanium alloy layers are not sufficient to withstand the stresses of a rolling bodies guide, such as a watch bearing.

Micro-arc oxidation can also be used to create a dense surface layer on alloys comprising naturally dense passive oxide wires. The alloy part is immersed in a basic bath and an alternating electric current is applied. The electric arcs created will oxidize the surface to a thickness of around 10 μm to 150 μm. Only the lower layer (approx. 65%) is dense, the outer surface is porous and must be removed.

The surface roughness induced by this treatment is detrimental to the characteristics of freedom required for the correct operation of a watchmaking or medical rolling bodies guide device. Moreover, the dimensions of the components used in watchmaking and/or medical rolling bodies guides are below the limits of what can be achieved using this technique.

Structural hardening of titanium or a titanium alloy is also possible, but the hardness values achieved by this treatment do not meet the requirements of rolling bodies guide devices for watchmaking or medical applications.

Galvanic deposition processes enable the deposition of different types of material. Hardened electroless nickel can reach high hardness levels, but the risk of delamination from the treatment prevents their use for high load applications.

To sum up, it is not currently possible to manufacture rolling bodies guide devices in materials (such as titanium or titanium alloys) that do not a priori have the properties required for the watchmaking or medical sectors.

Document FR2136037 concerns a hardening process for metal parts such as watch cases, a machete button, etc., which have to meet aesthetic requirements as they have visible surfaces. The part is made of titanium and is first shaped and then exposed at high temperature (approx. 1100° C. or 1400° C.-1500° C.) and low pressure to the diffusion of oxygen, nitrogen, hydrogen or a mixture of these gases, followed by rapid cooling. The treatment is carried out at low pressures and for a limited time.

Document CH539128 is like document FR2136037.

Document EP1146136 relates to an ornament, such as an external ornamental part of a watch, which comprises a substrate comprising stainless steel, titanium or a titanium alloy. First an external force is applied to create a deformed layer with a thickness of 2 μm to 100 μm. Then, a hardened layer with a thickness of 5 μm to 50 μm is formed by diffusion of a carbon, nitrogen or oxygen atom at a temperature of 100° C. to 500° C. A hard coating film such as TiC or TiN is deposited on the hardened layer.

Document US2020199725 describes a hardening process for achieving a surface hardness of 900 HV or more, which is sufficient to provide scratch resistance for components in watches, jewelry, eyeglasses and the like where visual appeal is important.

### BRIEF SUMMARY OF THE INVENTION

One aim of the present invention is to provide a method of manufacturing a medical rolling bodies guide device free from the limitations of known bearings.

A further aim of the invention is to provide a method of manufacturing a medical rolling bodies guide device in a material which does not a priori have the properties required for a medical rolling bodies guide.

A further aim of the invention is to provide a method of manufacturing a medical rolling bodies guide device that meets the requirements of watchmaking or medical rolling bodies guide devices.

According to the invention, these aims are achieved in particular by means of a method for manufacturing such a rolling bodies guide device according to claim 1, and by means of a rolling bodies guide device according to claim 10.

The invention relates to a method of manufacturing a rolling bodies guide device for a medical mechanism, comprising components, said components comprising:
a first element,
a second element,
rolling bodies arranged between the first element and the second element, to facilitate relative displacement of the first element with respect to the second element or vice versa,
at least one component being made of titanium or a titanium alloy, the method comprising the steps of
processing, e.g. machining, the titanium or titanium alloy component,
performing a diffusion hardening treatment of the machined component, so that the component comprises a surface layer having a hardness in the range 900 Hv-1100 Hv.

According to the invention, a titanium or titanium alloy component of a medical rolling bodies guide device is first machined (in its “soft” state, i.e. before hardening), and then diffusion-hardened.

The process therefore involves processing, e.g. machining, at least one component of the rolling bodies guide device from a material that does not have the properties required for a medical rolling bodies guide device, and then hardening it so that it has these required properties.

This does not prevent the component from being reworked (or re-machined) after the hardening treatment, in one variant. It is also possible that the hardening treatment will have to be repeated after this subsequent re-machining step, if necessary.

The use of titanium or a titanium alloy for a medical rolling bodies guide device is surprising, as its hardness is not sufficient for such devices.

Among all the known processes for hardening titanium or a titanium alloy, the applicant has selected a specific type of hardening treatment, known in the watchmaking industry, particularly for watch cases, but not for rolling bodies guide devices.

This specific type of hardening treatment was known to improve the aesthetic appearance of a watch case. Often aesthetics is not important for a rolling bodies guide device, which generally remains hidden to a user of the part or of the device in which it is mounted. So, the applicant had no incentive to try this type of known treatment.

In addition, medical rolling bodies guides have small dimensions compared to parts hardened with this specific type of known hardening treatment. For example, the maximum diameter of the outer element (outer ring or bushing) of a rolling bodies guide device for a medical mechanism is 28 mm. Since small parts react differently to thermal cycling, for example by deforming, once again the applicant had no incentive to try this known type of treatment.

In particular, this solution has the advantage over the prior art of obtaining for (at least) one component of the rolling bodies guide device, at least one component of which is made of titanium or a titanium alloy, with a surface layer having a hardness in the 900 Hv-1100 Hv range, making it suitable for the medical field.

Furthermore, the Young's modulus of the treated component material, as well as its geometric dimensions, are little or not at all affected by the diffusion hardening treatment, which only modifies its surface hardness, improving it.

The aesthetic appearance of the treated component is slightly different from that of the untreated component (the color is slightly darker and matte). However, in medical rolling bodies guide device applications, this slight change is of no significance. It may be possible—after the hardening treatment—to remove a few micrometers of the surface layer, for example by pickling, in order to obtain an aesthetic appearance more similar to that of the untreated component.

It is essential that the medical rolling bodies guide component is first processed, e.g. machined, and then hardened, since otherwise the high risk of removing a large part of the surface layer (i.e. the hardened or treated layer) during machining would make it impossible to obtain a high-quality rolling bodies guide device suitable for the medical field.

In a variant, the surface layer is defined between an outer surface and an inner surface, the inner surface being adjacent to a base layer (i.e. an untreated layer) of the component, the process comprising the step of:
performing a (purely or predominantly) interstitial diffusion hardening treatment, so that the hardness of the surface layer decreases from the outer surface to the inner surface.

In this variant, the gradual decrease in hardness improves the charge transfer between the surface layer and the base layer.

In another, less preferred, variant, the diffusion is (purely or mostly) substitutional.

According to the invention, the diffusion hardening treatment comprises the step of immersing the part in a gas.

According to the invention, this gas comprises at least one atom selected from carbon, nitrogen, argon or oxygen.

According to the invention, the process comprises the step of selecting a temperature to carry out the hardening, for example a temperature substantially higher than ambient temperature, for example a temperature in the range 300° C.-1100° C., preferably between 500° C.-800° C.

In one variant, the process includes the step of controlling the temperature during hardening, to allow diffusion while avoiding the growth of unwanted phases or compounds, such as carbides, nitrides or oxides, for example.

According to the invention, the process includes the step of selecting a pressure to carry out the hardening, for example a pressure higher than the atmospheric pressure, for example a pressure that can reach several times the atmospheric pressure.

According to the invention, the hardening treatment time is in the range 1 h-24 h.

In a variant, the step of diffusion hardening of the machined component is a final step in the manufacturing process.

In a variant, the treated component has at least one dimension and/or mass greater than that of the desired final component, and the process comprises after the hardening treatment step, the step of:
cutting the treated component, in order to limit deformations due to the hardening treatment.

In fact, the hardening process deforms the treated component. It is therefore desirable to treat a component with at least one dimension and/or mass greater than that of the desired component, for example at least twice as great, in order to limit its deformation during treatment, and to cut it after treatment in order to obtain the component with the desired shape, dimensions and/or mass.

In a rotary bearing, the clearance depends on the dimensions of the parts. The bearing's axial clearance is very important, as it defines the contact angle between the rolling bodies.

This means that a rotating bearing (e.g. a deep groove bearing) must be adjusted after the hardening treatment. Adjusting on a component treated with the hardening treatment according to the invention is not possible, because the layer thickness is too small.

In one embodiment, the guide device is a rotary bearing, the process comprises after the hardening treatment step the step of:
regulating an axial clearance of the rotary bearing during assembly of the guide device.

In one embodiment, the guide device comprises a first inner ring (cone) and a second inner ring (core), the axial clearance being adjusted by pressing the first inner ring (cone) onto the second inner ring (core). The invention also relates to a rolling bodies guide device for a watch or medical mechanism, comprising (at least) a first element and (at least) a second element. Rolling bodies are arranged between the first element and the second element, to facilitate relative displacement of the first element with respect to the second element or vice versa.

According to the invention, at least one component is made of titanium and/or titanium alloy and comprises a surface layer of treated titanium and/or treated titanium alloy, said surface layer having a hardness in the range 900 Hv-1100 Hv.

This hardness ensures effective load transfer and meets the requirements of rolling bodies guide devices used in the watchmaking and medical sectors.

In one variant, the surface layer is defined between an outer surface and an inner surface, the inner surface being adjacent to a base layer (i.e. an untreated layer) of the component, the hardness of the surface layer decreasing from the outer surface towards the inner surface. In this variant, there is a continuity favorable to load transfer between the surface layer and the base layer.

In one variant, the surface layer 21 has a thickness in the range of 5 μm-50 μm. This thickness also provides sufficient load-bearing capacity for watchmaking and/or medical applications.

In a variant, the components comprise a cage arranged to hold the rolling bodies.

In one variant, the rolling bodies guide device is a rotary bearing.

In one variant, the rolling bodies guide device is a linear bearing.

In one variant, the rolling bodies guide device is a ball screw.

The present invention also relates to an implantable medical device comprising the rolling bodies guide device according to the invention. In a variant, the rolling bodies guide device according to the invention is used to minimize friction loss and/or increase the service life of medical implants.

### BRIEF DESCRIPTION OF FIGURES

Examples of implementation of the invention are shown in the description illustrated by the appended figures in which:

FIG. 1 illustrates a perspective view of an example of a watch mechanism comprising a rotating bearing according to one embodiment of the invention.

FIG. 2 shows a top view of the watch mechanism shown in FIG. 1.

FIG. 3 shows a cross-sectional view along plane B-B of the watch mechanism shown in FIG. 2.

FIG. 4 shows a top view of part of the bearing of the watch mechanism shown in FIG. 1.

FIG. 5 shows a perspective view of the bearing shown in FIG. 4.

FIG. 6 schematically illustrates the steps of the manufacturing process according to the invention.

FIG. 7 shows a cross-sectional view of a portion of a component of the rolling bodies guide device according to the invention.

FIG. 8A shows a perspective view of a component of the rolling bodies guide device, before the diffusion hardening treatment of the process according to the invention.

FIG. 8B shows a perspective view of a part of a component of the rolling bodies guide device, after the diffusion hardening treatment of the process according to the invention and after a cutting step.

FIG. 9A illustrates a cross-sectional view of a rolling bodies guide device in the form of a rotary bearing, to show an example of radial clearance.

FIG. 9B shows a cross-section of the rolling bodies guide device shown in FIG. 9A, to illustrate an example of axial clearance.

FIG. 10 shows a cross-sectional view of a rolling bodies guide device in the form of a rotary bearing according to the invention, to demonstrate one embodiment of adjusting axial clearance.

### EXAMPLE(S) OF EMBODIMENT OF THE INVENTION

In the following description by way of example, reference will be made, for simplicity's sake, to a unidirectional rotary bearing. However, the invention is not limited to such a unidirectional bearing, but also covers other rolling bodies guide devices, e.g. bidirectional rotary bearings, linear bearings or screw balls.

In the following exemplary description, reference will be made, for simplicity's sake, to a bearing comprising an outer ring (monobloc), two inner rings fixed between them, a cage and rolling bodies held in the cage and arranged between the outer ring and the two inner rings. It should be understood, however, that the invention is not limited to such an embodiment, but also includes all rolling bodies guide devices covered by the claims, including for example similar bearings but comprising a number of inner rings greater than two; bearings comprising (at least) two outer rings, a (monobloc) inner ring, a cage and rolling bodies held in the cage and arranged between the outer rings and the inner ring; bearings comprising (at least) two outer rings, (at least) two inner rings, a cage and rolling bodies held in the cage and arranged between the outer rings and the inner rings; or bearings comprising a single-piece inner ring, a single-piece outer ring, a cage and rolling bodies held in the cage and arranged between the outer ring and the inner ring, bearings without a cage, or linear bearings or ball screws.

The invention has applications in the field of watchmaking. It also has applications in the medical field, in particular when the rolling bodies guide device is used in a medical device that can be implanted in a living body, such as a human body.

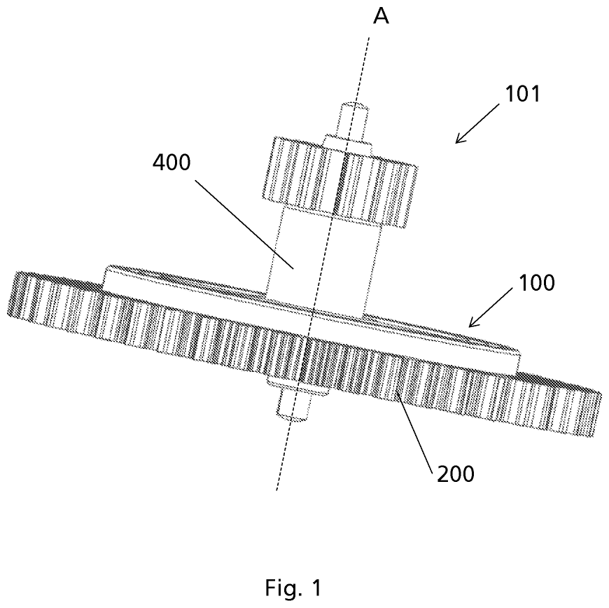

FIG. 1 illustrates a perspective view of an example of a watch mechanism 101 comprising the bearing 100, here rotatable, according to one embodiment of the invention. The watch mechanism 101 of FIG. 1 comprises a wheel 200, cooperating (directly or indirectly) with an oscillating weight (not illustrated), as well as a pinion 400, cooperating (directly or indirectly) with an energy source (not illustrated) of a watch movement, for example a barrel.

In the example shown, wheel 200 and pinion 400 are coaxial, i.e. they rotate around the same axis of rotation A.

When the wheel 200 rotates in a first direction around its center, bearing 100 transmits this rotation to pinion 400. When the wheel 200 rotates in a second direction opposite to the first, the bearing 100 does not transmit this rotation to the pinion 400.

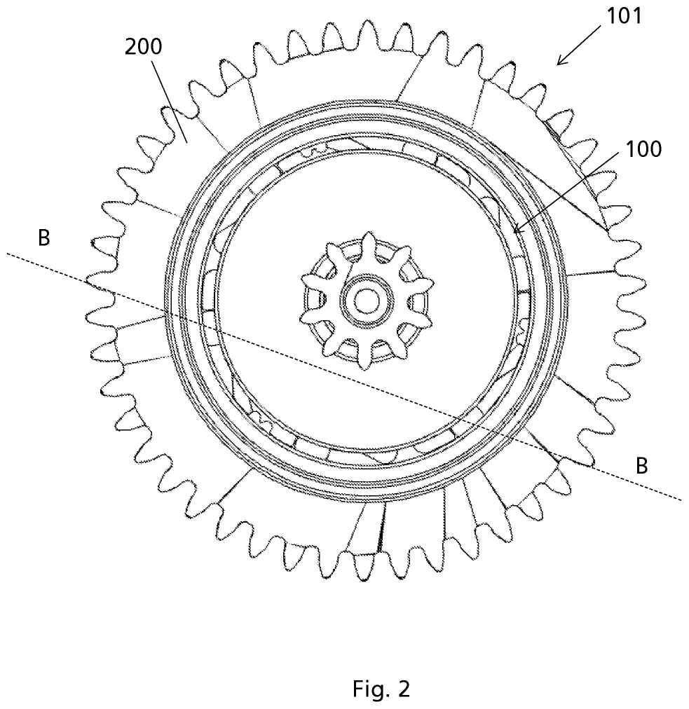

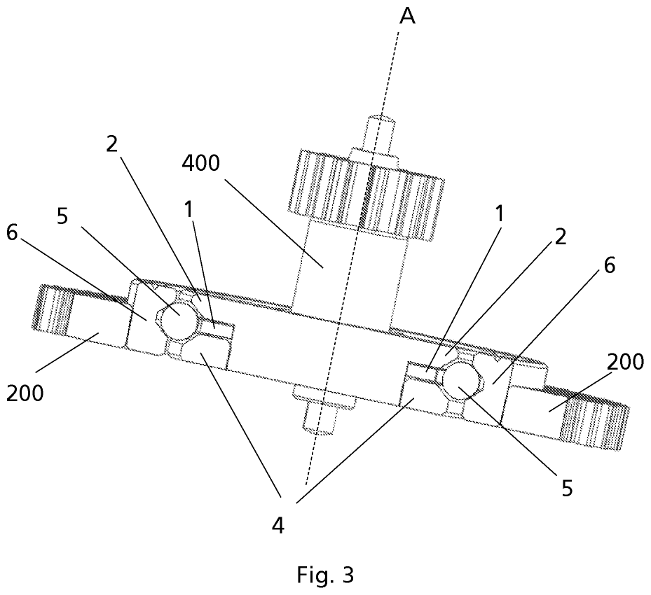

FIG. 2 shows a top view of the watch mechanism shown in FIG. 1. FIG. 3 shows a cross-sectional view along plane B-B of the watch mechanism shown in FIG. 2.

The bearing 100 shown in FIG. 3 comprises a cage 1, an outer ring 6 and two inner rings 2, 4, which are fastened together, for example, in a removable or non-removable manner. It also comprises rolling bodies 5, such as balls, held in cage 1 and arranged between outer ring 6 and the two inner rings 2, 4.

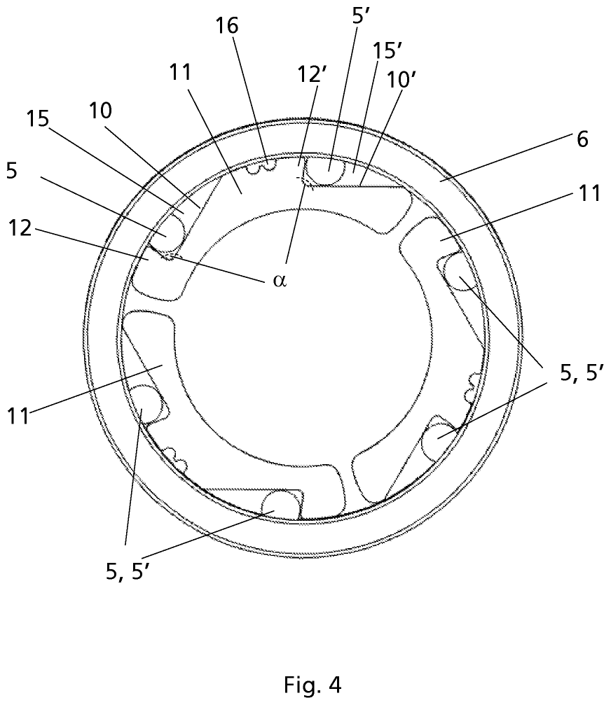

As shown in FIG. 4, which illustrates a top view of part of the bearing 100 of the watch mechanism in FIG. 1, the cage 1 comprises three segments 11, having the same shape and being evenly spaced between them. However, the invention is not limited to a cage 1 comprising several segments 11, as it is also applicable to a one-piece cage 1. Nor is the invention limited to the number of segments 11 shown in FIG. 4, since in the event of the cage 1 comprising segments 11, a number of segments 11 other than three can be envisaged.

Each segment 11 in FIG. 4 comprises two inclined planes 10, 10′. However, the invention is not limited to segments 11 each comprising two inclined planes 10, 10′, as only one inclined plane 10 or 10′ is required per segment/cage. Nor is the invention limited to the presence of inclined planes in the cage.

In the example shown in FIG. 4, the angles α of the inclined planes 10, 10′ of each segment 11 are identical to each other and to the angles of the other segments 11. In one variant, the value of the angle α is between 78° and 88°.

In another variant, one or more segments 11 each comprise inclined planes along a non-linear ramp. In one variant, this non-linear ramp is degressive, so that when the rolling bodies ascends the inclined plane, there is always the same angle between the ramp, and the straight line passing through the centers of the rolling bodies and the bearing. This type of ramp improves blocking, particularly in small bearings.

Each segment 11 defines, with the inner rings 2, 4 and the outer ring 6, a space 15 designed to receive a rolling bodies 5, for example a ball. In a preferred variant, the ball has three or four points of contact with rings 2, 4, 6.

In the locking direction of rotation, when ring 6 is driven clockwise in FIG. 4, balls 5, 5′ move up the inclined plane 10, respectively 10′ of each segment 11, until they are trapped between segment 11 and inner ring 2 on the one hand, and outer ring 6 on the other. In this case, the bearing 100 is in clutch mode and the rotation of the wheel 200, fixed to the outer ring 6, is transmitted via the inner rings 2, 4 to the pinion 400.

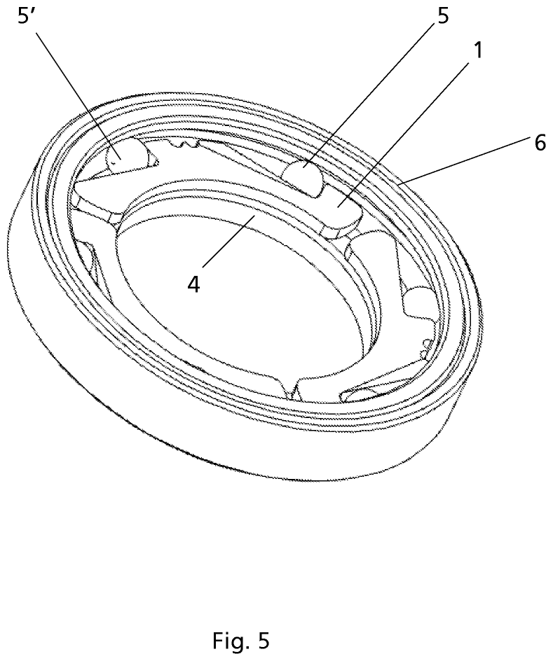

As shown in FIG. 5, in the direction of rotation opposite to the locking direction, which is counter-clockwise in FIG. 4, the balls 5, 5′ move down the inclined plane 10, respectively 10′ of each segment 11, until they are blocked by a stop surface 12, respectively 12′ of each segment 11. In this case, bearing 100 is in disengagement mode and wheel 200 rotation is not transmitted to pinion 400.

Each segment 11 in FIG. 4 has a shape that creates a second space 16: this shape/space holds the segment 11 in place during electrical discharge machining cutting. However, this shape is not restrictive, nor is its presence necessary. For example, when the segment is stamped, each segment 11 will lack the shape that creates this second gap 16.

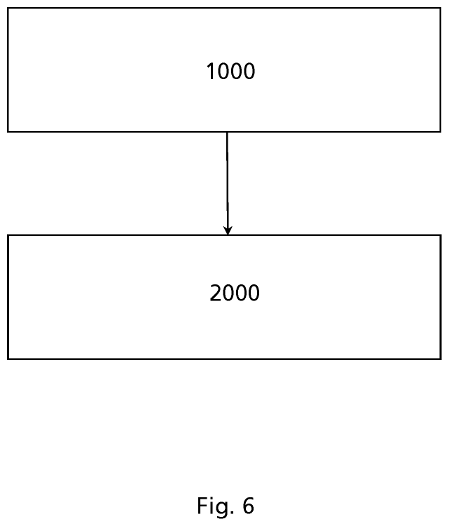

FIG. 6 schematically illustrates the steps of the manufacturing process according to the invention. This process comprises the steps of
processing at least one component of the rolling bodies guide device (step 1000),
performing a diffusion hardening treatment on the machined component, so that the component comprises a surface layer with a hardness in the range 900 Hv-1100 Hv (step 2000).

According to the invention, a titanium or titanium alloy component of a watch or medical rolling bodies guide device is first machined (in its “soft” state, i.e. before hardening), and then diffusion-hardened.

The process therefore involves processing, e.g. machining, at least one component of the rolling bodies guide device in a material that does not have the properties required for a watch or medical bearing, and then hardening it so that it has these necessary properties.

The hardness in the 900 Hv-1100 Hv range makes the rolling bodies guide device according to the invention suitable for the watchmaking or medical sectors. In addition, the Young's modulus of the treated component material, as well as the geometric dimensions of the treated part, are little or not at all affected by the diffusion hardening treatment.

It is essential to first processing, e.g. machining, the component of the watch or medical rolling bodies guide device (step 1000), and then harden it (step 2000), as otherwise the high risk of removing the surface layer (i.e. the hardened or treated layer) during machining would make it impossible to obtain a quality bearing suitable for the watch or medical sector.

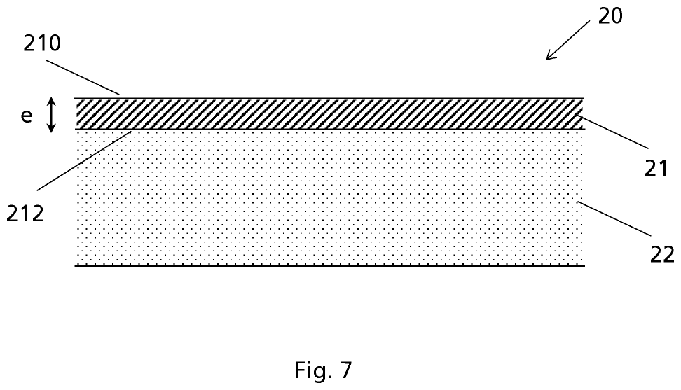

FIG. 7 shows a cross-sectional view of a portion of a component 20 of the rolling bodies guide according to the invention. This component 20 may be the outer ring 6, the inner ring 2, 4, a rolling bodies 5, 5′ or possibly a cage.

Preferably, this component 20 is an inner ring 2, 4, as it is subjected to high stresses in a watch or medical bearing.

In a variant, the surface layer 21 is defined between an outer surface 210 and an inner surface 212, the inner surface 212 being adjacent to a base layer 22 (i.e. an untreated layer) of the component. The proportions of layers 21, 22 shown in FIG. 7 do not necessarily correspond to the real ones.

In a variant, the process comprises the step of:
performing a (purely or predominantly) interstitial diffusion hardening treatment, so that the hardness of the surface layer 21 decreases from the outer surface 210 to the inner surface 212.

In this variant, the gradual reduction in hardness improves load transfer between the surface layer and the base layer.

In another, less preferred, variant, the diffusion is (purely or mostly) substitutional.

In one variant, the surface layer has a thickness e, visible in FIG. 7, in the range 5 μm-50 μm. This thickness e also provides sufficient load-bearing capacity for watchmaking and/or medical applications.

According to the invention, diffusion hardening treatment comprises the step of immersing the part in a gas, for example a gas comprising at least one atom selected from carbon, nitrogen, argon or oxygen.

According to the invention, the process comprises the step of selecting a temperature to carry out the hardening, for example a temperature substantially higher than ambient temperature, for example a temperature in the range 500° C.-800° C.

In a variant, the process includes the step of controlling the temperature during hardening, to allow diffusion while avoiding the growth of unwanted phases or compounds, such as carbides, nitrides or oxides.

According to the invention, the process includes the step of selecting a pressure to carry out the hardening, for example a pressure higher than atmospheric (for example it can reach several times atmospheric pressure).

According to the invention, the hardening treatment time is in the range 1 h-24 h.

The holding time in a treatment chamber, under target pressure and temperature, defines the depth of the surface layer 21, for a given material.

In an unclaimed variant, the diffusion-hardened bearing component is made of stainless steel.

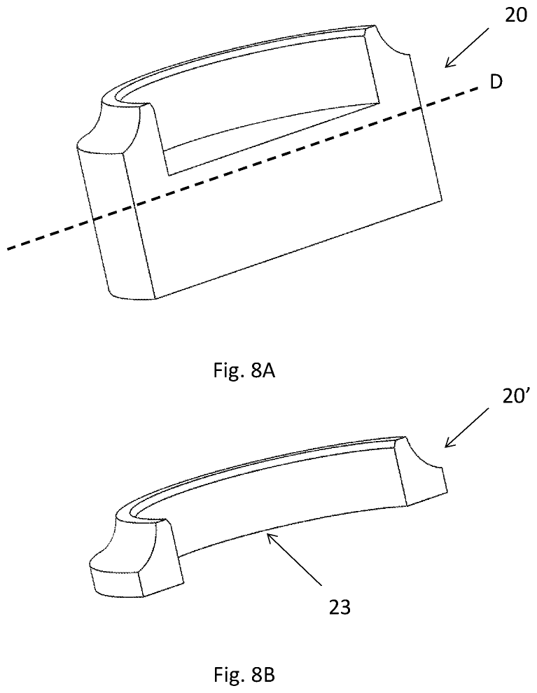

FIG. 8A shows a perspective view of a component 20 of the rolling bodies guide device before the diffusion hardening treatment of the process according to the invention.

The hardening treatment according to the invention deforms the treated component 20. In particular, the hardening treatment can modify the shape, at least one dimension and/or the mass of the treated component. In one embodiment, the hardening treatment modifies at least one dimension by up to 1% of its length. It is therefore desirable to treat a component 20 having at least one dimension and/or mass greater than that of the desired final component, for example at least twice as great, to limit its deformations during treatment, and to cut it after treatment, in order to obtain the component having the desired shape, dimensions and/or mass. For example, if a flat and thin processed component (i.e., having at least one dimension less than one tenth of its other dimensions) is to be obtained, in one embodiment, a thick (i.e., not thin) initial component will be treated with the hardening treatment, and will then be cut, to obtain the desired thin component, so that the cutting surface is flat: as the cutting surface has not been treated, it will not present any change in shape due to the treatment and will have the desired flatness.

In a variant, the treated component has at least one dimension and/or mass greater than that of the desired final component, and the process comprises after the hardening treatment step the step of:
cutting the treated component, in order to limit deformations due to the hardening treatment.

FIG. 8A shows a possible cutting line D for component 20, after processing.

FIG. 8B shows a perspective view of a part of the (final) component 20′ of the rolling bodies guide device after the diffusion hardening treatment of the process according to the invention and after cutting along the cutting line D of FIG. 8B.

The component 20′ comprises (at least) one untreated surface (bottom surface 23 in FIG. 8B), but the cutting line D is chosen so that this untreated surface is non-functional in the guide device.

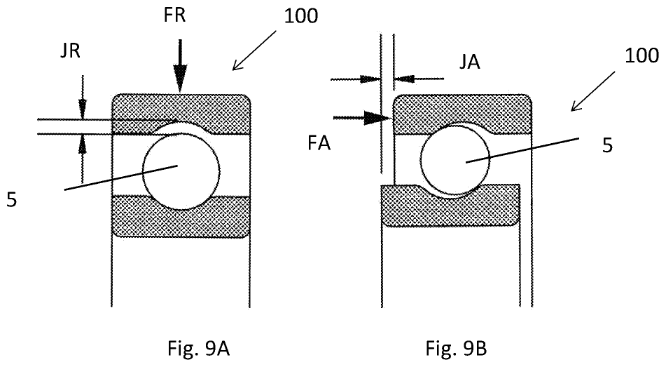

FIG. 9A illustrates a cross-sectional view of a rolling bodies guide device 100 in the form of a rotary bearing, to show an example of the radial clearance JR, following the application of a radial force FR.

FIG. 9B illustrates a cross-sectional view of the rolling bodies guide device 100 of FIG. 9A, to show an example of axial clearance JA, following the application of an axial force FA.

In a rotary bearing, the clearance depends on the dimensions of the parts. The axial clearance JA of the bearing is very important, as it defines the contact angle of the rolling bodies 5 with the ring(s).

This means that a rotating bearing (e.g. a deep groove bearing) must be adjusted after the hardening treatment. Adjusting on a component treated with the hardening treatment according to the invention is not possible because the layer thickness is too small. Adjusting would remove at least part, if not all, of the treated layer. In one embodiment, the guide device is a rotary bearing, the process comprises after the hardening treatment step, the step of:
regulating an axial clearance of the rotary bearing during assembly of the guide device.

This avoids removing the treated layer when adjusting axial clearance.

In one embodiment, the guide device comprises a first inner ring 4 (cone) and a second inner ring 2 (core), the axial clearance being adjusted by pressing the first inner ring (cone) 4 onto the second inner ring (core) 4.

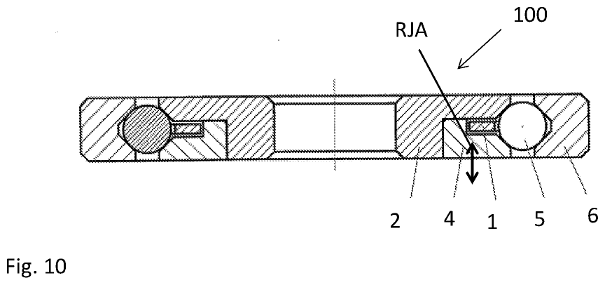

FIG. 10 shows a cross-sectional view of a rolling element guide 100 in the form of a rotary bearing according to the invention, to demonstrate one embodiment of adjusting the axial clearance RJA, by pressing the first inner ring (cone) 4 onto the second inner ring (core) 4.

### NUMBERS AND REFERENCE SIGNS USED ON FIGS

1 Cage
2 First inner ring
4 Second inner ring
5 Rolling bodies
6 Outer ring
10, 10′ Inclined plane
11 Cage segment
12, 12′ Stopping surface
15, 15′ First space
16 Second space
20, 20′ Component
21 Surface layer
22 Base layer
23 Untreated surface
100 Bearing
101 Watch mechanism
200 Wheel
210 External surface
212 Internal surface
400 Pinion
1000 Machining stage
2000 Diffusion hardening treatment step
A Rotation axis
D Cutting line
e Surface layer thickness
FA Axial force
FR Radial force
JA Axial clearance
JR Radial clearance
RJA Axial clearance adjustment

1. Method of manufacturing a rolling bodies guide device for a medical mechanism, comprising components, said components comprising:
a first element,
a second element,
rolling bodies arranged between the first element and the second element, to facilitate relative displacement of the first element with respect to the second element,
at least one component being made of titanium or a titanium alloy
the method comprising the steps of
processing the titanium or titanium alloy component;
performing a diffusion hardening treatment on the machined component,
the diffusion hardening treatment comprising a step of immersing the titanium or titanium alloy component in a gas.
the gas comprising at least one atom selected from carbon, nitrogen, argon or oxygen,
the process comprising the steps of:
selection of a temperature in the range 500° C.-800° C.,
selection of a pressure greater than atmospheric,
wherein the hardening treatment time is in the range 1 h-24 h,
so that the component comprises a surface layer has a hardness in the range 900 Hv-1100 Hv.

2. Method according to claim 1, the surface layer being defined between an outer surface and an inner surface, the inner surface being adjacent to a base layer of the component, the method comprising the step of:
performing an interstitial diffusion hardening treatment, whereby the hardness of the surface layer decreases from the outer surface to the inner surface.

3. Method according to claim 1, the surface layer having a thickness in the range 5 μm-50 μm.

4. Method according to claim 1, the treated component having at least one dimension and/or mass greater than that of the desired final component, the process comprising after the hardening treatment step the step of:
cutting the treated component, in order to limit deformations due to the hardening treatment.

5. Method according to claim 1, the guide device being a rotary bearing, the method comprising after the hardening treatment step the step of:
adjusting an axial clearance of the guide device during assembly of the guide device.

6. Method according to claim 5, the rotary bearing comprising a first inner ring and a second inner ring, the axial clearance being adjusted by pressing the first inner ring onto the second inner ring.

7. Rolling bodies guide device for a medical mechanism, manufactured using the method according to claim 1, the device comprising at least the following components:
a first element,
a second element,
rolling bodies arranged between the first element and the second element to facilitate relative displacement of the first element with respect to the second element,
in which
at least one component is made of titanium and/or titanium alloy and comprises a surface layer of treated titanium and/or treated titanium alloy, said surface layer having a hardness in the range 900 Hv-1100 Hv.

8. Device according to claim 7, the surface layer being defined between an outer surface and an inner surface, the inner surface being adjacent to a base layer of the component, the hardness of the surface layer decreasing from the outer surface towards the inner surface.

9. Device according to claim 7, the surface layer having a thickness in the range 5 μm-50 μm.

10. Device according to claim 7, the components comprise a cage arranged to hold the rolling bodies.

11. Device according to claim 7, being a rotary bearing, a linear bearing or a ball screw.

12. Implantable medical device, comprising the rolling bodies guide device according to claim 7.
